(19) United States
(12) Patent Application Publication
(10) Pub. No.: US 2009/0255968 A1
(43) Pub. Date: Oct. 15, 2009

(54) FOLD-OUT AND EXTENDING STORAGE CONTAINER

(76) Inventors: Douglas J. Golenz, Littleton, CO (US); Joe Settelmayer, McKinleyville, CA (US)

Correspondence Address: NOVAK DRUCE AND QUIGG, LLP (Thule), 1000 LOUISIANA STREET, FIFTY-THIRD FLOOR, HOUSTON, TX, 77002, US

(21) Appl. No.: 12/351,650

(22) Filed: Jan. 9, 2009

Related U.S. Application Data
(60) Provisional application No. 61/020,308, filed on Jan. 10, 2008.

(51) Int. Cl. B60R 11/00

(52) U.S. Cl. 224/549

(57) ABSTRACT

The invention is generally directed towards systems, arrangements and methods that permit fixable and releasable mounting of equipment on mounting surfaces. More specifically these systems, arrangements and methods relate to fixable or releasable mounting of a fold-out and extending storage container for use with transporting vehicles, particularly recreational vehicles, to attach to different mounting locations about the interior or exterior of the recreational vehicle. Utilizing various fasteners known in the art, the fold-out and extending storage container is fixably mounted to mounting surfaces. Utilizing a plurality of receivers configured to be at least semi-permanently coupled to mounting surfaces about the interior and exterior of the recreational vehicle, the fold-out and extending storage container is releasably mounted to mounting surfaces. The storage container is pivotally attached to the mounting arrangement to allow the user to pivot or rotate the storage container into a use and a stored configuration.

### CROSS REFERENCE TO RELATED APPLICATIONS

The present application claims priority to U.S. Provisional Application 61/020,308 filed Jan. 10, 2008. Said application is expressly incorporated herein by reference in its entirety.

### TECHNICAL FIELD

The present invention relates, generally, to a system for organizing and mounting equipment on mounting surfaces. More specifically, the invention relates to a fold-out and extending storage container for use with transporting vehicles, particularly recreational vehicles, to attach to different mounting locations about the interior or exterior of the transporting vehicle.

### BACKGROUND

Recreational pursuits are becoming an evermore important part of today's leisure lifestyles. As a result, recreational products, including recreational vehicles and the various associated systems and accessories, are becoming an increasingly attractive product category.

The present disclosure appreciates that most recreational vehicles (RVs), whether motorized or towed, have limited space for storing items in the interior or exterior of the recreational vehicle. The present disclosure further appreciates the desirability of being able to attach storage containers at various mounting locations in the interior or exterior of the RV to store various items or accessories; and also the ability to stow the storage container such that space within the interior of the RV remains available for other uses. Therefore, the need has been recognized for a means that accommodates variously locating stowable storage containers at varied locations about the interior or exterior of the vehicle.

In the many and varied pursuits to develop means for attaching storage containers to planar surfaces, hooks, fasteners and nails are often used for fixably mounting the storage container to the mounting surface. Reliable means for fixably securing storage containers directly to a planar surface include screws, bolts, and the like. However, direct and fixed attachment of a storage container to a mounting surface may require subsequent repositioning of the storage container into a different or stowed position. Accordingly, this subsequent repositioning has the disadvantage of requiring the removal of the screw, bolt or similar permanent fastener to release the storage container from the mounting surface. These fixably mounted storage containers have the further disadvantage of consuming a substantial amount of space due to the non-stowable and protruding nature of such containers. Consumption of space is especially disadvantageous in RVs where the interior and exterior space is limited and necessary for other uses. Fixable attachment of storage containers to mountable surfaces is known (U.S. Pat. No. 5,899,420) wherein a storage container is fixably attached to a mounting device that is fixably attached to a mounting surface.

In view of the above-described limitations associated with known designs for mountable storage containers, the present invention has been developed to increase the utility of such devices and provide further benefits to the user. Such benefits include devices and methods providing optional structures for increased maneuverability and functionality of the storage container. These enhancements and benefits are described in greater detail herein below with respect to several alternative embodiments of the presently described systems, arrangements and methods.

### SUMMARY

The presently described systems, arrangements and methods have as a goal to permit accessories, subsystems, and related articles to be conveniently stored in a fold-out and extending storage container to be fixably or releasably mounted to a mounting surface in the interior or exterior of the RV, and most preferably, these systems, arrangements, and methods accommodate pivotal rotation of the storage container to a use and stored configuration at variable locations about the interior and exterior of the vehicle.

More particularly the present invention provides a system for accommodating mounting a storage container at various locations about a recreational vehicle. The system comprises a storage container, a mounting arrangement and a fastener for pivotally fastening the storage container to the mounting arrangement.

In accordance with the present invention, the storage container is adapted to fold out from a stored configuration and extend from one of the various locations. The storage container, in the stored configuration, lies proximate to the mounting arrangement and includes a clamping member to fix an end of the storage container to the support

Materials comprising the storage container in accordance with the system of the present invention include those selected from the group consisting of pliable, amorphous and rigid materials.

One embodiment of the system in accordance with the present invention includes the mounting arrangement having a support member and a mounting plate, the support member having movement relative to the mounting plate to allow the storage container to extend from the one of the various locations. The storage container is connected by the fastener to the support member. Connection of the fastener to the support member provides fold-out of the storage container from one of the various locations.

In an exemplary structure in accordance with the present invention, the mounting plate further comprises at least two opposing extensions, substantially at right angles to the mounting plate, each extension including at least one through hole having the support member slidingly mounted therein. In one embodiment the support member comprises two elongate support bars each slidingly mounted in one of the at least one through hole and joined at opposing ends by U-shaped end-cap bars. In addition, the mounting plate further includes a plurality of through holes for fixable fastening of the mounting plate to a mounting surface of the one of the various locations, using fasteners selected from the group consisting of screws, bolts, hooks and nails and the like.

Mounting surfaces in accordance with the system of the present invention optionally include mounting surfaces that are horizontal and vertical, including those wherein the mounting surface includes at least one receiver for releasable attachment of the mounting plate. The receiver further includes a lock for secure attachment of the mounting plate to the mounting surface.

The present invention also provides an assembly used for mounting each of a plurality of containers to a plurality of mounting surfaces at locations inside and outside a vehicle. The assembly comprises a mounting plate secured to one of the mounting surfaces, a support member in sliding engagement with the mounting plate and a fastener connecting the container to the support member for pivoting movement of the container relative to the mounting surface. The sliding engagement of the support member to the mounting plate allows movement from a stored configuration to extend the container from a one of the locations.

Also provided in accordance with the present invention is a process for mounting each of a plurality of containers to a plurality of mounting surfaces at locations inside and outside a vehicle. The process comprises securing a mounting plate to a one of the mounting surfaces for slidingly engaging a support member with the mounting plate. Connecting the container to the support member provides pivoting movement of the container relative to the mounting surface. The sliding engagement of the support member to the mounting plate allows movement from a stored configuration to extend the container from a one of the locations.

### BRIEF DESCRIPTION OF THE DRAWINGS

FIG. 1 is a front perspective view of the horizontally and fixably mounted fold-out and extending storage container in the use configuration in accordance with an exemplary embodiment.

FIG. 2 is a front perspective view of the horizontally and fixably mounted fold-out and extending storage container in the stored configuration in accordance with an exemplary embodiment.

FIG. 3 is a front perspective view of the horizontally and releasably mounted fold-out and extending storage container in the use configuration in accordance with an exemplary embodiment.

FIG. 4 is a front perspective view of the horizontally and releasably mounted fold-out and extending storage container in the stored configuration in accordance with an exemplary embodiment.

FIG. 5 is a front perspective view of the vertically and releasably mounted fold-out and extending storage container in accordance with an exemplary embodiment.

### DETAILED DESCRIPTION

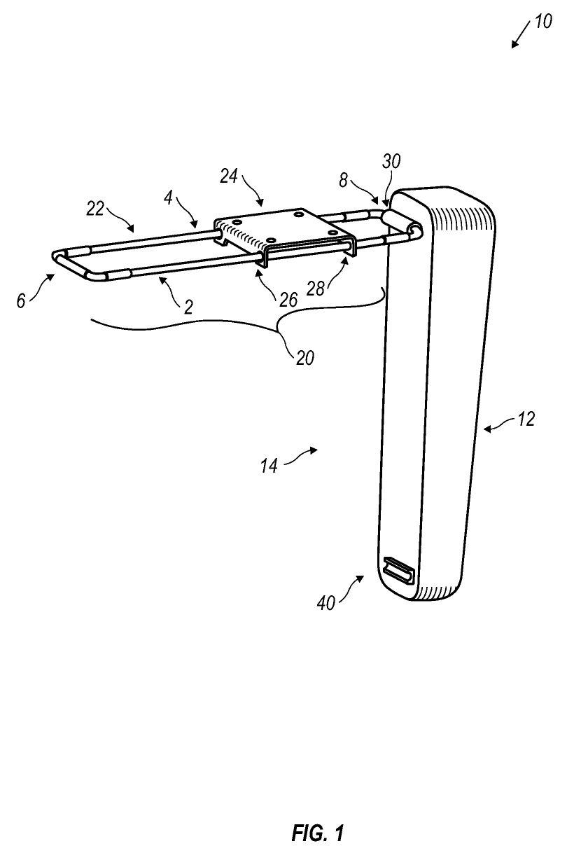

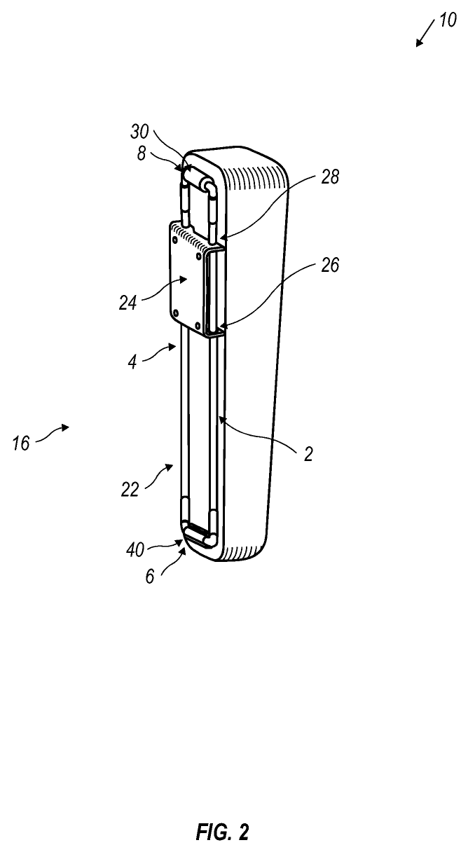

In one embodiment shown in FIG. 1, the fold-out and extending storage container (10) comprises a storage container (12), a mounting arrangement (20) and fastener (30) for pivotally fastening the storage container (12) to the mounting arrangement (20). The mounting arrangement (20) comprises a support member (22) and a mounting plate (24). The mounting plate (24) comprises two extensions (26, 28), substantially at right angles to the mounting plate, each with two through holes for accepting the support member (22). The mounting plate (24) further comprises through holes on its top surface for fixably fastening the mounting plate (24) to a horizontal mounting surface. The support member (22) comprises two elongate support bars (2, 4) with each bar adjoined at the proximate ends and distal ends by U-shaped end-cap bars (6, 8). The support bars (2, 4) can be slidingly mounted in the through holes of the mounting plate (24). The fold-out and extending storage container (10) is mounted to a horizontal mounting surface such that the mounting plate (24) is fixably fastened to the horizontal mounting surface by screws, bolts, hooks, fasteners, nails or other means contemplated by those of ordinary skill in the art. In this embodiment, the storage container (12) hangs vertically and perpendicular to the support member (22) in the use configuration (14) and is stowed horizontally, proximate and parallel to the support member (22) in the stored configuration (16) as shown in FIG. 2.

Referring to FIG. 2, the mounting arrangement (20) is pivotally attached or fastened to the storage container (12). In one or more embodiments, the fastener (30) can be a hinge, clamp, Velcro or other means contemplated by those of ordinary skill in the art for pivotally fastening the storage container (12) to the mounting arrangement (20). The fastener (30) allows the user to pivot or rotate the storage container (12) into a stored configuration (16) in which the storage container is proximate and parallel to the support member (22) and into a use configuration (14), shown in FIG. 1, wherein the storage container hangs vertically and perpendicular to the support member (22). In this embodiment, the storage container (12) is made of a pliable and amorphous material and a clamping member (40) is further provided to fix the proximate end of the storage container (12) to the support member (22) when the storage container (12) is in the stored configuration (16).

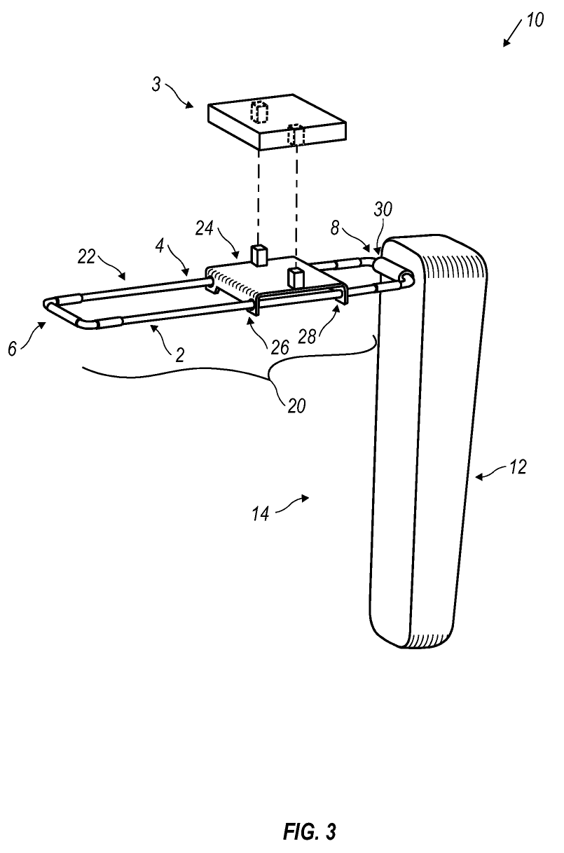

In another embodiment shown in FIG. 3, the fold-out and extending storage container (10) is releasably mounted to the interior or exterior of the RV. The fold-out and extending storage container (10) comprises a storage container (12), a mounting arrangement (20) and fastener (30) for pivotally fastening the storage container (12) to the mounting arrangement (20). The mounting arrangement (20) comprises a support member (22) and a mounting plate (24). The mounting plate (24) comprises two extensions (26, 28), substantially at right angles to the mounting plate, each with two through holes for accepting the support member (22). The support member (22) comprises two elongate support bars (2, 4) with each bar adjoined at the proximate ends and distal ends by U-shaped end-cap bars (6, 8). Mounting receivers (pods) (3) can be placed or located about the interior and exterior of the RV, and are configured for releasably receiving the mounting plate (24). For added security, a locking arrangement can be included as part of the mounting receiver (pods) (3) for securing the fold-out and extending storage container (10) until disengagement or repositioning.

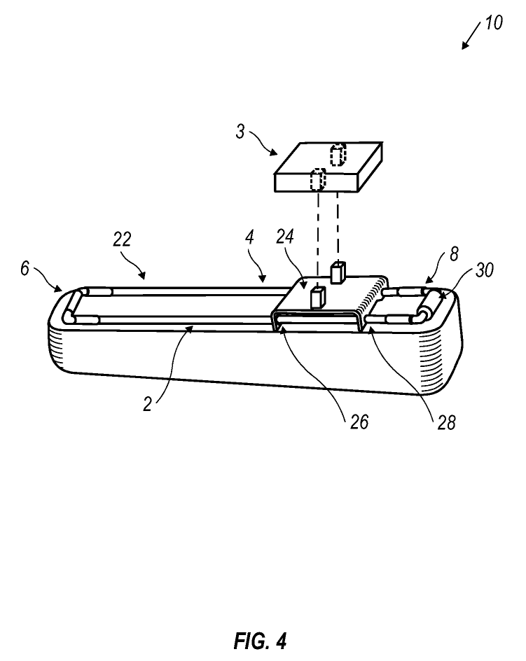

The fastener (30) can be a hinge, clamp, Velcro or other means contemplated by those of ordinary skill in the art for pivotally fastening the storage container (12) to the mounting arrangement (20). The fastener (30) allows the user to pivot or rotate the storage container (12) into a use configuration (14) wherein the storage container hangs vertically and perpendicular to the support member (22) as shown in FIG. 3 and into a stored configuration (16) in which the storage container is proximate and parallel to the support member (22) as shown in FIG. 4. The fold-out and extending storage container (10) is releasably mounted to a horizontal mounting surface such that the mounting plate (24) is releasably fastened to the horizontal mounting surface via the mounting receiver (pods) (3). In this embodiment, the storage container (12) is made from a rigidly shaped material.

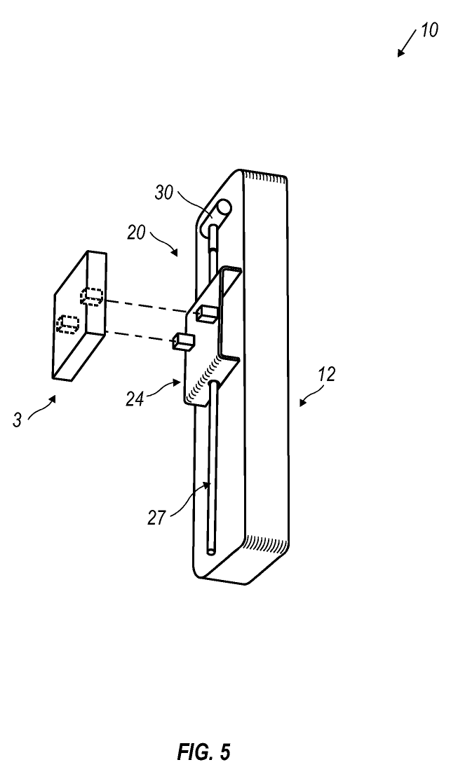

In yet another embodiment shown in FIG. 5, the fold-out and extending storage container (10) comprises a storage container (12), a mounting arrangement (20) and fastener (30) for pivotally fastening the storage container (12) to the mounting arrangement (20). The mounting arrangement (20) comprises a support member (27) and a mounting plate (24). The mounting plate (24) comprises two extensions (26, 28), substantially at right angles to the mounting plate, each with a through hole for accepting the support member or an elongate bar (27). Mounting receivers (pods) (3) are located about the interior and exterior of the RV, and are configured for releasably receiving the mounting plate (24). For added security, a locking arrangement can be included as part of the mounting receiver (pods) (3) for securing the fold-out and extending storage container (10) until disengagement or repositioning.

The fastener (30) can be a hinge, clamp, Velcro or other means contemplated by those of ordinary skill in the art for pivotally fastening the storage container (12) to the mounting arrangement (20). The fold-out and extending storage container (10) is releasably mounted to a vertical mounting surface such that the mounting plate (24) is releasably fastened to the vertical mounting surface via the mounting receiver (pods) (3). In this embodiment, when the fold-out and extending storage container (10) is mounted vertically, the storage container (12) hangs vertically in the use and stored configurations, as shown in FIG. 5.

As may be appreciated by one of ordinary skill in the art, many variations in the combinations and configurations of the presently described systems, arrangements and methods can be made without departing from the scope of the presently claimed invention.

What is claimed is:

1. A system for accommodating mounting a storage container at various locations about a recreational vehicle, the system comprising:
a storage container;
a mounting arrangement; and
a fastener for pivotally fastening the storage container to the mounting arrangement.

2. The system recited in claim 1, wherein the storage container is adapted to fold out from a stored configuration and extend from one of the various locations.

3. The system recited in claim 2, wherein, in the stored configuration, the storage container lies proximate to the mounting arrangement.

4. The system recited in claim 2, wherein, the storage container includes a clamping member to fix an end of the storage container to the support member when the storage container is in the stored configuration.

5. The system recited in claim 2, wherein the storage container comprises a material selected from the group consisting of pliable, amorphous and rigid materials.

6. The system recited in claim 1, wherein the mounting arrangement comprises a support member and a mounting plate, the support member having movement relative to the mounting plate to allow the storage container to extend from the one of the various locations, the storage container having a connection by the fastener to the support member.

7. The system recited in claim 6, wherein the connection to the support member provides fold-out of the storage container from the one of the various locations.

8. The system recited in claim 6, wherein the mounting plate further comprises at least two opposing extensions, substantially at right angles to the mounting plate, each extension including at least one through hole having the support member slidingly mounted therein.

9. The system recited in claim 8, wherein each extension includes two through holes and wherein the support member comprises two elongate support bars each slidingly mounted one in each wo through hole and joined at opposing ends by U-shaped end-cap bars.

10. The system recited in claim 6, wherein the mounting plate further includes a plurality of through holes for fixable fastening of the mounting plate to a mounting surface of the one of the various locations using fasteners selected from the group consisting of screws, bolts, hooks and nails and the like.

11. The system recited in claim 10, wherein the mounting surface is horizontal.

12. The system recited in claim 10, wherein the mounting surface is vertical.

13. The system recited in claim 12, wherein the mounting surface includes at least one receiver for releasable attachment of the mounting plate.

14. An assembly used for mounting each of a plurality of containers to a plurality of mounting surfaces at locations inside and outside a vehicle, the assembly comprising:
a mounting plate secured to one of the mounting surfaces;
a support member in sliding engagement with the mounting plate; and
a fastener connecting the container to the support member for pivoting movement of the container relative to the mounting surface, the sliding engagement of the support member to the mounting plate allowing movement from a stored configuration to extend the container from a one of the locations.

15. A process for mounting each of a plurality of containers to a plurality of mounting surfaces at locations inside and outside a vehicle, the process comprising the steps of:
securing a mounting plate to one of the mounting surfaces;
slidingly engaging a support member with the mounting plate; and
connecting the container to the support member for pivoting movement of the container relative to the mounting surface, the sliding engagement of the support member to the mounting plate allowing movement from a stored configuration to extend the container from a one of the locations.
